(19) United States
(12) Patent Application Publication
(10) Pub. No.: US 2013/0173637 A1
(43) Pub. Date: Jul. 4, 2013

(54) METHOD, SERVER, AND TERMINAL FOR RECOMMENDING AN APPLICATION BASED ON APPLICATION USAGE

(71) Applicant: Samsung Electronics Co., Ltd., Gyeonggi-do (KR)

(72) Inventors: Kyung-Joong KIM, Gyeonggi-do (KR); Sang-Youl LEE, Seoul (KR); Young-Seop LEE, Gyeonggi-do (KR)

(73) Assignee: Samsung Electronics Co., Ltd., Gyeonggi-do (KR)

(21) Appl. No.: 13/729,456

(22) Filed: Dec. 28, 2012

(30) Foreign Application Priority Data
Dec. 29, 2011 (KR) 10-2011-0146126

(51) Int. Cl. G06F 17/30

(52) U.S. Cl. CPC G06F 17/30283
USPC 707/748; 707/736

(57) ABSTRACT

A server, terminal, and method are provided for recommending an application according to application usage. The server includes a recommendation database that stores application usage information and additional information of a user terminal; a statistic processor that compiling statistics of applications using the stored additional information and generates an application statistic list from the compiled statistics; and a controller that determines a rank for the generated application statistic list using the application usage information, generates a candidate list based on the determined rank, and stores the generated application statistic list and the generated candidate list in the recommendation database.

### PRIORITY

This application claims priority under 35 U.S.C. §119(a) to Korean Patent Application Serial No. 10-2011-0146126, which was filed in the Korean Intellectual Property Office on Dec. 29, 2011, the entire disclosure of which is hereby incorporated by reference.

### BACKGROUND OF THE INVENTION

1. Field of the Invention

The present invention relates generally to a server, a terminal, and a method for recommending an application, and more particularly, to a server, a terminal, and a method for recommending an application list according to user application usage.

2. Description of the Related Art

As the popularity of smart phones has increased, a number of application stores have been established, which offer and distribute software applications to these smart phones.

Generally, an application store categorizes the applications that are available through the application store and provides information about applications corresponding to a particular category in order to recommend an application to a user. More specifically, when a user selects one of the multiple categories, the application store provides a recommendation list of applications corresponding to the selected category. Conventionally, the recommendation list ranks the applications in the list based on their respective popularity, i.e., based on the number of previous downloads by other users. However, even though an application has been downloaded a number of times by other users, this does not ensure that the application should be recommended to a particular user.

### SUMMARY OF THE INVENTION

Accordingly, the present invention is designed to address at least the problems and/or disadvantages described above and to provide at least the advantages described below.

An aspect of the present invention is to provide a server, a terminal, and a method that provide an application recommendation list to a particular user, based on the user's previous application usage.

In accordance with an aspect of the present invention, a server is provided for providing an application recommendation list to a particular user, based on user application usage. The server includes a recommendation database that stores application usage information and additional information of a user terminal, a statistic processor that compiling statistics of applications using the stored additional information and generates an application statistic list from the compiled statistics, and a controller that determines a rank for the generated application statistic list using the application usage information, generates a candidate list based on the determined rank, and stores the generated application statistic list and the generated candidate list in the recommendation database.

In accordance with another aspect of the present invention, a method is provided for providing an application recommendation list to a particular user, by a server, based on user application usage. The method includes receiving application usage information and additional information of a user terminal, storing the application usage information and the additional information in a recommendation database, compiling statistics of applications using the stored additional information, generating an application statistic list from the compiled statistics, determining a rank for the generated application statistic list using the application usage information, generating a candidate list based on the determined rank, and storing the generated application statistic list and the generated candidate list in the recommendation database.

In accordance with another aspect of the present invention, a terminal is provided for providing an application recommendation list to a particular user, based on user application usage. The terminal includes a controller that collects application usage information and additional information, forwards the collected application usage information and the collected additional information to a recommendation server, and receives an application recommendation list from the recommendation server, and a display that displays the received application recommendation list.

In accordance with another aspect of the present invention, a method is provided for providing an application recommendation list to a particular user, by a terminal, based on user application usage. The method includes collecting application usage information and additional information, forwarding the application usage information and the additional information to a recommendation server, and receiving an application recommendation list from the recommendation server.

### BRIEF DESCRIPTION OF THE DRAWINGS

The above and other aspects, features, and advantages of certain embodiments of the present invention will be more apparent from the following detailed description taken in conjunction with the accompanying drawings, in which:

FIG. 1 illustrates a system that recommends applications, according to an embodiment of the present invention;

FIG. 2 illustrates a user terminal that recommends applications according to an embodiment of the present invention;

FIG. 3 is a flowchart illustrating a method of a user terminal for requesting and receiving an application recommendation list from a recommendation server according to an embodiment of the present invention;

FIG. 4 illustrates a server and a recommendation DataBase (DB) according to an embodiment of the present invention;

FIG. 5 is a flowchart illustrating a method of a server for providing a recommendation list according to an embodiment of the present invention;

FIG. 6 illustrates a screen for inputting basic user basic information according to an embodiment of the present invention; and

FIG. 7 illustrates a screen of a user terminal that displays an application recommendation list according to an embodiment of the present invention.

### DETAILED DESCRIPTION OF EMBODIMENTS OF THE INVENTION

Various embodiments of the present invention will now be described in detail with reference to the accompanying drawings. In the following description, specific details such as detailed configuration and components are merely provided to assist the overall understanding of these embodiments of the present invention. Therefore, it should be apparent to those skilled in the art that various changes and modifications of the embodiments described herein can be made without departing from the scope and spirit of the present invention. In addition, in the following description and the accompanying drawings, well-known functions and structures will not be described in detail to avoid unnecessarily obscuring the subject matter of the present invention.

In accordance with an embodiment of the present invention, a system is provided including a server and a terminal. The terminal periodically provides application usage information and additional information, such as installation and uninstallation information of applications, usage information, terminal unique information, etc., to the server, which collects the application usage information and the additional information and compiles statistics thereof to generate a recommendation list (or an application recommendation list), and provides the generated recommendation list to a user. Accordingly, the recommendation list according to present invention is properly suited to the individual user.

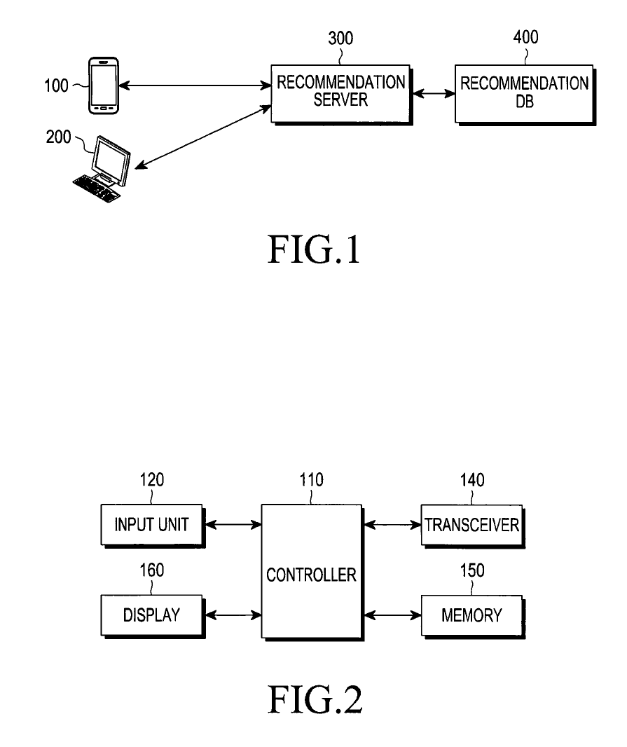

FIG. 1 illustrates a system that recommends applications, according to an embodiment of the present invention.

Referring to FIG. 1, the system includes a mobile terminal 100, a Personal Computer (PC) 200, a recommendation server 300, and a recommendation DB 400. The mobile terminal 100 and the PC 200 download and install applications, and run and reproduce the installed applications in order to provide the applications to the user. A user terminal such as the mobile terminal 100 or the PC 200 may be a smart phone, a tablet PC, etc.

The user terminal periodically collects application usage information, such as installation and uninstallation information, a running duration, the number of times an application is run, log information for an application, etc., and additional information, such as terminal information of the user terminal and basic user information. Thereafter, the user terminal provides the collected application usage information and additional information to the server 300. The user terminal also collects feedback information for applications and delivers the feedback information to the recommendation server 300. Herein, the feedback information includes rating information made by the user regarding an application.

The user terminal forwards a request for an application recommendation list to the server 300, receives the application recommendation list corresponding to the request from the server 300, and displays the received application recommendation list on a screen of the user terminal. In accordance with an embodiment of the present invention, the server 300 may provide the application recommendation list at the request of the user terminal, as described above, or may periodically provide the application recommendation list to the user terminal, without any request of the user terminal.

The server 300 periodically receives application usage information and additional information regarding user terminals, and stores the information in the recommendation DB 400. Further, the server 300 compiles statistics of the applications by using the received additional information, generates an application statistic list, and stores the application statistic list in the recommendation DB 400. Thereafter, the server 300 determines ranks for the applications by using the application usage information, generates a plurality of candidate lists using the ranked applications, and stores the plurality of candidate lists in the recommendation DB 400. The server 300 also stores the feedback information received from the user terminal in the recommendation DB 400.

When the user terminal requests the recommendation list request from the server 300, the server 300 sends a candidate list corresponding to the recommendation list request from among the plurality of candidate lists to the user terminal. For example, the server 300 filters the recommendation list by referring to the feedback information stored in the recommendation DB 400. As indicated above, the server 300 may also periodically generate a candidate list and provide the generated candidate list to the user terminal, without any request from the user terminal.

FIG. 2 illustrates a user terminal that recommends applications according to an embodiment of the present invention. Specifically, FIG. 2 illustrates the mobile terminal 100 as the user terminal.

Referring to FIG. 2, the mobile terminal 100 includes a controller 110, an input unit 120, a transceiver 140, a memory 150, and a display 160. Herein, the term “unit” refers to a hardware device or a combination of a hardware device and software.

The controller 110 controls overall operation of the mobile terminal 100, and in particular, collects application usage information and additional information of the mobile terminal 100 and forwards the collected application usage information and additional information to the server 300 through the transceiver 140. As described above, the application usage information of the mobile terminal 100 includes application installation and uninstallation information indicating which applications are installed or uninstalled, a number of times an application has been run, a running duration during which an application is run, a number of times an application is run per day of the week, a sum of running durations per day of the week, etc. The additional information of the mobile terminal 100 includes basic user information such as age, gender, nationality, etc., and personal information about the user such as a name, a phone number, local information, etc. If the basic user information and the personal information are not previously set, the controller 110 may configure a user interface for setting the basic information and the personal information and receive the basic information and the personal information from the user through the input unit 120. The use of the basic user information and the personal information may require approval of the user.

For example, if a collection period is once a week, the controller 110 collects the application usage information and the additional information once a week, stores the information in the memory 150, and forwards the stored information to the server 300.

Further, information associated with running of an application, a running duration and a number of times of running may be stored for each application in the form of a log, and as the server 300 determines a rank based on the running duration and the number of times of running, a candidate list may be generated on a basis of a particular day of the week or a week.

Upon receiving the application recommendation list from the server 300 through the transceiver 140, the controller 100 displays the received application recommendation list through the display 160.

Thereafter, the controller 110 collects feedback information corresponding to each application in the application recommendation list, stores the feedback information in the memory 150, and forwards the stored feedback information to the server 300. For example, the feedback information includes recommendation list feedback information and feedback information using a Social Network Service (SNS). Herein, the recommendation list feedback information includes information that collects recommendation rating information regarding a recommended application, and the feedback information using the SNS includes information that collects recommendation rating information regarding a recommended application a user uploads to the SNS via a PC or a portable terminal.

For example, the feedback information using the SNS may include information about whether application information is posted on an SNS website, a number of times the posted information is re-posted, the number of comments regarding the posted information, preference information and rating information received from other users via the SNS, and a number of times the previously posted information is transmitted via an e-mail. The feedback information is used by the server 300 to determine ranks of the applications for generating an application recommendation list.

The input unit 120 generates and outputs an input signal corresponding to a user input. For example, the input unit 120 may include physical buttons, a touch screen input, voice recognition, etc.

The transceiver 140 forwards the application usage information, the additional information, and the feedback information to the server 300. The transceiver 140 receives the application recommendation list from the server 300.

The memory 150 stores the application usage information, the additional information, and the feedback information.

The display 160 displays a screen for inputting basic user information and displays the application recommendation list received from the server 300.

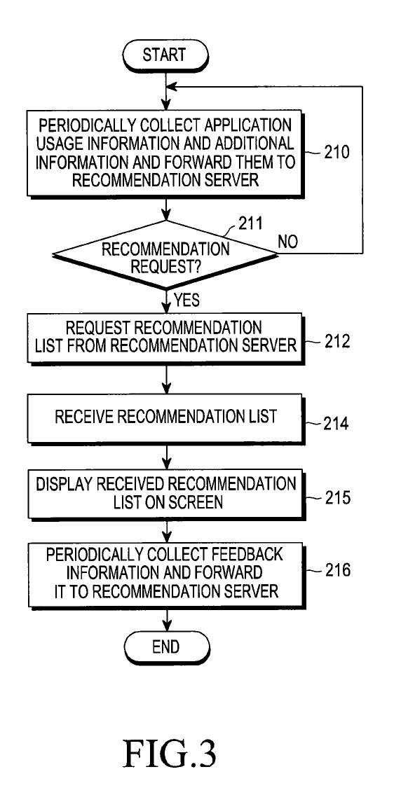

FIG. 3 is a flowchart illustrating a method of a user terminal for requesting and receiving an application recommendation list from a recommendation server according to an embodiment of the present invention.

Referring to FIG. 3, in step 210, the controller 110 periodically collects application usage information and additional information, stores the collected application usage information and additional information in the memory 150, and forwards the stored application usage information and additional information to the server 300.

In step 211, the controller 110 determines whether there is an application recommendation list request. When there is no application recommendation list request, the controller 110 continues to periodically collect the application usage information and the additional information, store the collected application usage information and additional information in the memory 150, and forward the stored application usage information and additional information to the server 300 in step 210, until there is an application recommendation list request in step 211.

When there is an application recommendation list request, step 211, the controller 110 forwards the application recommendation list request to the recommendation server 300 through the transceiver 140 in step 212.

In step 214, the controller 110 receives the application recommendation list from the server 300 through the transceiver 140.

In step 215, the controller 110 displays the received application recommendation list through the display 160. For example, the screen of the display 160 may include names, images, reasons for a recommendation, prices of the applications included in the application recommendation list, etc.

In step 216, the controller 110 periodically collects feedback information for the recommended applications, stores the collected feedback information in the memory 150, and forwards the stored feedback information to the server 300.

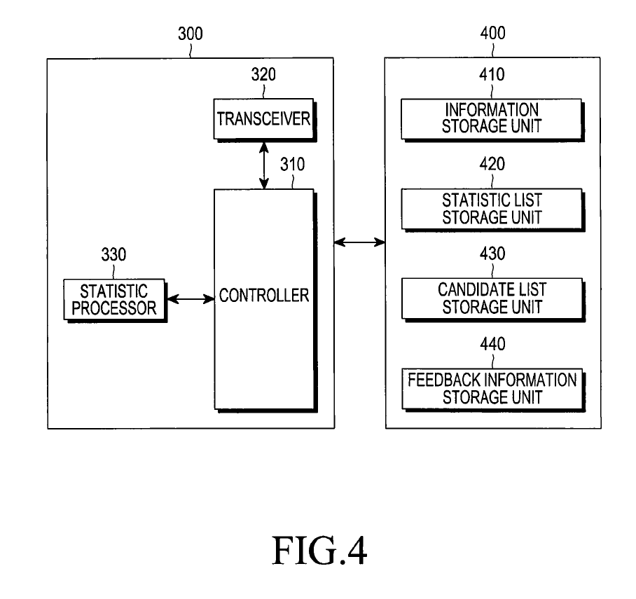

FIG. 4 illustrates a server and a recommendation DB according to an embodiment of the present invention.

Referring to FIG. 4, the server 300 includes a controller 310, a transceiver 320, and a statistic processor 330, and the recommendation DB 400 includes an information storage unit 410, a statistic list storage unit 420, a candidate list storage unit 430, and a feedback information storage unit 440. Herein, the recommendation DB 400 is included in a memory device, such as a hard drive.

Additionally, although the server 300 and the recommendation DB 400 are illustrated as separate components in FIG. 4, the recommendation DB 400 may also be included in the server 300.

The controller 310 of the server 300 performs overall operation of the server 300, and in particular, stores application usage information and additional information, which are periodically received from the mobile terminal 100 through the transceiver 320, in the information storage unit 410 of the recommendation DB 400.

The controller 310 controls the statistic processor 330 to compile statistics of the applications using the stored additional information and to generate an application statistic list. The controller 310 stores the generated application statistic list in the statistic list storage unit 420. For example, the controller 310 may control the statistic processor 330 to generate statistic lists of applications installed by teenage males or females, males or females in their 20s, and male or females in the 30s, according to age and gender.

The controller 310 then determines ranks for the application statistic lists generated using the stored application usage information and generates a candidate list. Thereafter, the controller 310 stores the generated candidate list in the candidate list storage unit 430. For example, the controller 310 determines ranks of the applications in an order starting from an application that has been run the most number of times to an application that has been run the least number of times, for the last seven days, from among applications installed by teenage males, lists the applications, and generates the listed applications as a candidate list.

Upon receiving the application recommendation list request from the mobile terminal 100 through the transceiver 320, the controller 310 selects a candidate list corresponding to the additional information of the mobile terminal 100 as an application recommendation list from among a plurality of candidate lists, and forwards the selected application recommendation list to the mobile terminal 100 through the transceiver 320. Alternatively, the controller 310 may periodically generate a candidate list and provide it to the mobile terminal 100, without any request from the mobile terminal 100.

Upon receiving feedback information regarding recommended applications from the mobile terminal 100 through the transceiver 320, the controller 310 stores the received feedback information in the feedback information storage unit 440. The stored feedback information is used as reference information for filtering during the selection of a candidate list, thus improving the accuracy of the recommendation list selected for the user. For example, the controller 310 may exclude an application earning the worst rating from users from the application recommendation list.

The transceiver 320 may periodically receive application usage information and additional information from the mobile terminal 100, or receive an application recommendation list request from the mobile terminal 100. The transceiver 320 forwards the selected application recommendation list to the mobile terminal 100.

The statistic processor 330 compiles statistics of the applications using the stored additional information and then generates an application statistic list.

As indicated above, the controller 310 determines a rank for the application statistic list by using the stored application usage information, and generates a candidate list.

For example, the controller 310 may use a user's preferred category for applications, preference by gender and age, recommendation by nation, the number of top downloads for the last two weeks, an order of top average running durations, an order of applications recommended through an SNS, etc. The candidate list may be selected as a recommendation list suitable for a user through filtering based on rate setting between charged and free applications, exclusion of applications of a particular category, feedback information for recommended applications, etc.

For example, if there is a recommendation list request from a female user in her 20s from a particular nation, the controller 310 selects a candidate list for applications preferred by 20 year old females from among candidate lists stored in the candidate list storage unit 430 according to preset popularity ranks by nation, gender, and age, and provides the selected candidate list as an application recommendation list to the user. If the particular nation prohibits the use of game-related applications, the controller 310 excludes applications corresponding to the game category from the recommendation list through filtering.

The information storage unit 410 of the recommendation DB 400 stores the application usage information and the additional information received from the mobile terminal 100.

The statistic list storage unit 420 stores the application statistic list generated by the statistic processor 330.

The candidate list storage unit 430 stores the candidate list generated by the controller 310.

The feedback information storage unit 440 periodically stores feedback information, such as a recommendation preference, according to a plurality of applications received from the user. By using the feedback information, the controller 310 determines a low rank for an application having a low recommendation preference. By reflecting the feedback information in recommendation list selection, a recommendation algorithm of the server 300 may be verified, and a user preference may be recognized for each application.

The feedback information storage unit 440 stores share information for a recommended application through an SNS, such as a number of posting times, preference rating upload, and re-posting for application information through an SNS, such that if the level of sharing of an application is high, the controller 310 may raise a recommendation rank for that application.

Further, the feedback information storage unit 440 stores device information, such as remaining memory capacity and network access speed of a device, for filtering with respect to a recommendation list, such that the controller 310 may exclude a large-volume application based on the network access speed from the recommendation list. For example, the controller 310 may recommend a large-volume application in a network state in which large-volume application transmission is possible such as WiFi, but if the network state cannot transmit a large-volume application or the remaining memory capacity of the mobile terminal 100 is low, the controller 310 may exclude the large-volume application from the recommendation list.

Although filtering is performed in the embodiment described above, when the recommendation list is provided, alternatively, the filtering may be performed when the controller 310 generates the candidate list.

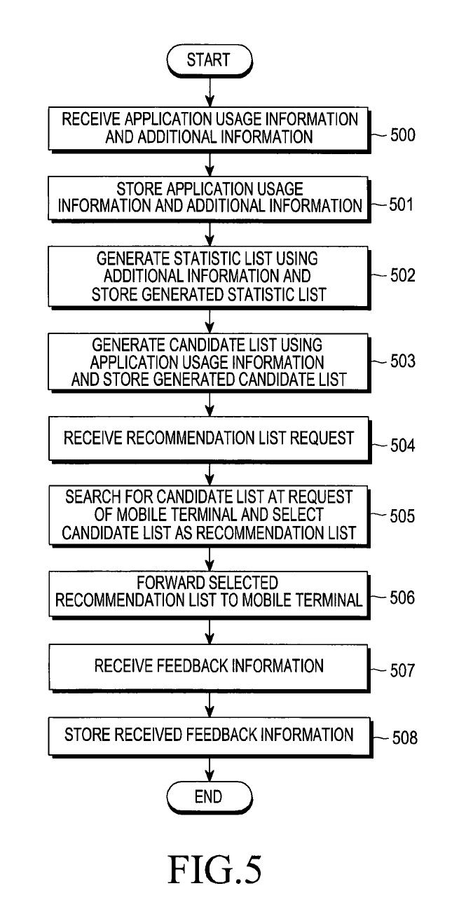

FIG. 5 is a flowchart illustrating a method of a server for providing a recommendation list according to an embodiment of the present invention.

Referring to FIG. 5, in step 500, the controller 310 receives application usage information and additional information from the mobile terminal 100.

In step 501, the controller 310 stores the application usage information and the additional information received from the mobile terminal 100 in the information storage unit 410. The application usage information and additional information of a plurality of terminals, as well as the application usage information and the additional information of the mobile terminal 100, are stored in the information storage unit 410.

In step 502, the controller 310 compiles statistics of the applications through the statistic processor 330 using the stored additional information, generates an application statistic list, and stores the generated application statistic list in the statistic list storage unit 420.

In step 503, the controller 310 determines ranks for application statistic lists by using the stored application usage information, generates a candidate list, and stores the generated candidate list in the candidate list storage unit 430.

In step 504, the controller 310 receives an application recommendation list request from the mobile terminal 100.

In step 505, the controller 310 searches for a candidate list among a plurality of candidate lists at the request of the mobile terminal 100, and selects a found candidate list as an application recommendation list.

In step 506, the controller 310 forwards the selected application recommendation list to the mobile terminal 100 through the transceiver 320.

In step 507, the controller 310 receives feedback information regarding a recommended application from the mobile terminal 100.

In step 508, the controller 310 stores the received feedback information in the feedback information storage unit 440.

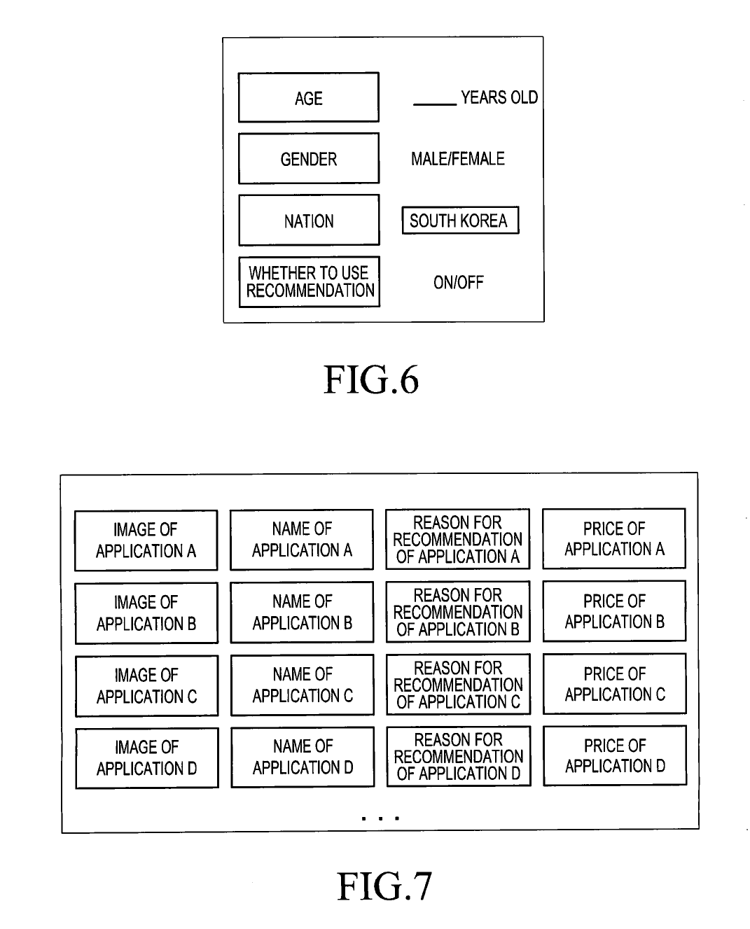

FIG. 6 illustrates a screen for inputting basic user information according to an embodiment of the present invention.

Referring to FIG. 6, when basic user information, such as age, gender, nationality, and a recommendation setting, i.e., whether to use recommendations, is not set in the mobile terminal 100, the mobile terminal 100 configures a screen for receiving input of the basic user information as illustrated in FIG. 6 and then receives input of the basic user information from the user. However, because the basic user information and other personal information are unique to the user, approval of the user may be a requirement for using this information.

FIG. 7 illustrates a screen of a user terminal that displays an application recommendation list according to an embodiment of the present invention.

Referring to FIG. 7, an application recommendation list received from the server 300 may be displayed according to a preset user interface. For example, in FIG. 7, images, names, reasons for recommendations of applications A through D, and prices of the applications A through D, are displayed on the screen. Thus, the user may be provided with an application the user desires to install or download among applications of the recommendation list.

For recommendation criterion information and filtering conditions used by the server 300, a separate setting interface may be provided to set a recommendation list by a store or a manager when necessary, such that scalability of the server 300 may be improved.

Accordingly, the above-described embodiments of the present invention provide an application recommendation list with which a user can easily check and download an application that is suitable to the user's application usage characteristics, thereby improving user convenience in application downloading.

While the present invention has been particularly shown and described with reference to certain embodiments thereof, it will be understood by those of ordinary skill in the art that various changes in form and details may be made therein without departing from the spirit and scope of the present invention as defined by the following claims and their equivalents.

What is claimed is:

1. A server that provides a recommended application based on application usage, the server comprising:
a recommendation database that stores application usage information and additional information of a user terminal;
a statistic processor that compiling statistics of applications using the stored additional information and generates an application statistic list from the compiled statistics;
a controller that determines a rank for the generated application statistic list using the application usage information, generates a candidate list based on the determined rank, and stores the generated application statistic list and the generated candidate list in the recommendation database.

2. The server of claim 1, wherein the recommendation database comprises:
an information storage unit that stores the application usage information and the additional information;
a statistic list storage unit that stores the generated application statistic list;
a candidate list storage unit that stores the generated candidate list; and
a feedback information storage unit that stores feedback information regarding a recommended application.

3. The server of claim 1, wherein the controller receives an application recommendation request from the user terminal and provides a candidate list suitable for the user terminal as an application recommendation list among a plurality of candidate lists.

4. The server of claim 1, wherein the controller periodically provides the generated candidate list to the user terminal as an application recommendation list.

5. The server of claim 4, wherein the controller filters the application recommendation list by using the feedback information to exclude an application from the application recommendation list.

6. The server of claim 1, wherein the application usage information comprises:
application installation or uninstallation information indicating whether an application is installed or uninstalled; and
application running information regarding an application, and
wherein the additional information comprises:
basic user information; and
personal information.

7. A method of recommending an application by a server, based on application usage, the method comprising:
receiving application usage information and additional information of a user terminal;
storing the application usage information and the additional information in a recommendation database;
compiling statistics of applications using the stored additional information;
generating an application statistic list from the compiled statistics;
determining a rank for the generated application statistic list using the application usage information;
generating a candidate list based on the determined rank; and
storing the generated application statistic list and the generated candidate list in the recommendation database.

8. The method of claim 7, further comprising receiving feedback information regarding a recommended application from the user terminal.

9. The method of claim 8, further comprising:
receiving an application recommendation request from the user terminal; and
providing a candidate list suitable for the user terminal as an application recommendation list from among a plurality of candidate lists.

10. The method of claim 7, further comprising periodically providing the generated candidate list to the terminal as an application recommendation list.

11. The method of claim 10, further comprising filtering the application recommendation list using feedback information in order to exclude an application from the application recommendation list.

12. The method of claim 7, wherein the application usage information includes application installation or uninstallation information indicating whether an application is installed or uninstalled and application running information regarding an application, and
wherein the additional information includes basic user information and personal information.

13. A terminal for recommending an application based on application usage, the terminal comprising:
a controller that collects application usage information and additional information, forwards the collected application usage information and the collected additional information to a recommendation server, and receives an application recommendation list from the recommendation server; and
a display that displays the received application recommendation list.

14. The terminal of claim 13, wherein the application usage information comprises:
application installation or uninstallation information indicating whether an application is installed or uninstalled; and
application running information regarding an application, and
wherein the additional information comprises:
basic user information; and
personal information.

15. The terminal of claim 13, wherein the controller periodically collects feedback information regarding a recommended application.

16. The terminal of claim 15, wherein the controller forwards the collected feedback information to the recommendation server.

17. The terminal of claim 14, wherein the feedback information comprises:
recommendation list feedback information indicating preference information regarding a recommendation list; and
feedback information using a Social Network Service (SNS).

18. A method for recommending an application by a terminal, based on application usage, the method comprising:
collecting application usage information and additional information;
forwarding the application usage information and the additional information to a recommendation server; and
receiving an application recommendation list from the recommendation server.

19. The method of claim 19, wherein the application usage information includes application installation or uninstallation information indicating whether an application is installed or uninstalled at particular time and application running information regarding an application, and
wherein the additional information includes basic user information and personal information.

20. The method of claim 19, further comprising:
periodically collecting feedback information regarding a recommended application; and
forwarding the collected feedback information to the recommendation terminal.
